(19) United States
(12) Patent Application Publication
(10) Pub. No.: US 2010/0301287 A1
(43) Pub. Date: Dec. 2, 2010

(54) Process for Treating Spent Nuclear Fuel

(75) Inventors: Michael Ernest Johnson, Richland, WA (US); Martin David Maloney, Evergreen, CO (US); Martin John Reibold, Louisville, CO (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(73) Assignee: CH2M Hill, Inc.

(21) Appl. No.: 11/561,861

(22) Filed: Nov. 20, 2006

Related U.S. Application Data
(60) Provisional application No. 60/843,461, filed on Sep. 8, 2006.

(51) Int. Cl. C09K 3/00

(52) U.S. Cl. 252/635

(57) ABSTRACT

Process for treating spent nuclear fuel (SNF) to make mixed metal oxides of UO₃ and PuO₂ to prevent nuclear proliferation. The process comprises the steps of (1) dissolving spent nuclear fuel in an acidic solution in the presence of an agent that reduces Pu⁺⁶ to Pu⁺⁴ and an agent that oxidizes Pu⁺³ to Pu⁺⁴; (2) extracting U⁺⁶ and Pu⁺⁴ from acidic solution with an organic solvent comprising a ligand that binds U⁺⁶ and Pu⁺⁴ and which is soluble in the organic solvent; (3) jointly extracting U⁺⁶ and Pu⁺⁴ from the organic solvent with an acidic aqueous solution; and (4) precipitating a mixture of U⁺⁶ and Pu⁺⁴ by adding a carboxylic acid to the acidic aqueous solution. The U⁺⁶ and Pu⁺⁴ precipitate is then be calcined to form a mixed metal oxide of UO₃ and PuO₂. Additional steps can result in the formation of a mixed metal oxide of UO₃, PuO₂ and NpO₂ as well as the removal and isolation of technecium from the SNF.

### TECHNICAL FIELD

Process for treating spent nuclear fuel to make mixed metal oxides of UO₃ and PuO₂ and mixed metal oxides of UO₃, PuO₂ and NpO₂.

### BACKGROUND OF THE INVENTION

Nuclear power plants generate spent nuclear fuel (SNF). SNF typically contains uranium, and other radioactive actinide elements such as neptunium, plutonium, americium and curium, radioactive rare earth elements, the radioactive transition metal technetium, as well as radioactive cesium and strontium.

FIG. 1 sets forth a prior art plutonium uranium extraction (PUREX) process for treating SNF. The fuel is dissolved in nitric acid. After solvent extraction to separate uranium and plutonium from other fission products, the uranium and plutonium mixture is partitioned and uranyl nitrate with fission products and other contaminants is purified and converted to its oxide, UO₃. Similarly, plutonium nitrate is purified and either converted to metal for weapons production or converted to its oxide, PuO₂ which is then used to fabricate nuclear fuel.

The PUREX process separates plutonium from uranium and other radionuclides present in SNF. As a consequence, there is an increased risk in the proliferation of plutonium and the generation of weapons of mass destruction if the PUREX process is used.

### SUMMARY OF THE INVENTION

It is therefore an object of the invention to process spent nuclear fuel to separate the maximum amount of components suitable for reuse as new fuel for energy purposes and unsuitable for reuse in the creation of nuclear weapons.

This object is achieved by processing spent nuclear fuel according to the processes of the invention to produce plutonium in combination with uranium. This combination of plutonium and uranium may be converted for reuse as new fuel.

In the process, plutonium and uranium are extracted as a mixture from SNF. The process comprises the steps of (1) dissolving spent nuclear fuel in an acidic solution in the presence of an agent that reduces Pu⁺⁶ to Pu⁺⁴ and an agent that oxidizes Pu⁺³ to Pu⁺⁴; (2) extracting U⁺⁶ and Pu⁺⁴ from acidic solution with an organic solvent comprising a ligand that binds U⁺⁶ and Pu⁺⁴ to form U⁺⁶ and Pu⁺⁶ ligand complexes that are soluble in the organic solvent; (3) jointly back-extracting U⁺⁶ and Pu⁺⁴ from the organic solvent with an acidic aqueous solution; and (4) precipitating a mixture of U⁺⁶ and Pu⁺⁴ by adding a carboxylic acid to the acidic aqueous solution. The U⁺⁶ and Pu⁺⁴ precipitate can then be calcined to form a mixed metal oxide of UO₃ and PuO₂ which may be processed and fabricated into fuel.

In a preferred embodiment, the acidic solution of step (1) comprises 1-4M nitric acid, the organic solvent of step (2) comprises n-dodecane, the ligand of step (2) comprises tributyl phosphate, the back-extracting of U⁺⁶ and Pu⁺⁴ from the organic phase in step (3) is with 0.1M nitric acid, and the carboxylic acid used in step (4) is oxalic acid.

The foregoing results in a mixture of plutonium and uranium oxide which is not directly useful to make nuclear weapons. However, the process can also be used to form a metal oxide mixture of UO₃, PuO₂ and NpO₂. Neptunium (Np⁺⁵) is also present in SNF. In order to include NpO₂ in the mixed metal oxide, the acid solution of step (1) should contain less than 0.01M nitrite. The Np⁺⁵ is oxidized to Np⁺⁶ by nitrite when 1-6M nitric acid is used in step (2). The Np⁺⁶ is then extracted into the organic solvent with U⁺⁶ and Pu⁺⁴. The Np⁺⁶, is back extracted from the organic solvent (step 3) by increasing the nitrite concentration to greater than 0.01M. It is then reduced to Np⁺⁴ using, for example, hydrazine. The solution is then heated to decompose the hydrazine, and then co-precipitated with the U⁺⁶ and Pu⁺⁴ during precipitation step (4). The precipitate is then calcined to form the metal oxide mixture of UO₃, PuO₂ and NpO₂. This mixture can be used to fabricate new fuel.

Technetium is a radioactive element found in spent nuclear fuel. It is a beta emitter with a half-life of approximately 210,000 years.

It is therefore a further object of the invention to process spent nuclear fuel to isolate technetium. Technetium can be isolated during the above process and can either be retained for nuclear fuel or immobilized for storage. The acid solution of step (1) contains Tc⁺⁷ which is extracted with the U+⁶ and Pu⁺⁴ during the solvent extraction of U⁺⁶ and Pu⁺⁴ in step (2). The Tc⁺⁷ is back-extracted from the organic solvent with a strong acid solution (e.g. 6M nitric acid). The U⁺⁶ and Pu⁺⁴ are then back-extracted from the organic solvent using a dilute acid solution (e.g. 0.1M nitric acid).

### BRIEF DESCRIPTION OF THE DRAWINGS

FIG. 1 is a flow diagram for the traditional PUREX process to separate plutonium and uranium and then plutonium from uranium.

FIG. 2 is a flow diagram showing a modified PUREX process wherein uranium and plutonium are separated from radionuclides to form a mixed oxide of plutonium and uranium.

FIG. 3 depicts the extent of uranium and plutonium precipitation at 90 minutes as a function of the ratio of oxalic acid to plutonium in 1.4 molar HNO₃.

FIG. 4 depicts the extent of uranium and plutonium precipitation at 90 minutes as a function of the ratio of oxalic acid to plutonium in 2 molar HNO₃.

FIG. 5 depicts the extent of uranium and plutonium precipitation at 90 minutes as a function of the ratio of oxalic acid to plutonium in 3 molar HNO₃.

### DETAILED DESCRIPTION OF THE INVENTION

The invention relates to new processes that use well understood and demonstrated solvent extraction technology to co-extract plutonium and uranium from dissolved SNF. This process is referred to as the PUREX-NPC™.

The PUREX-NPC™ process uses the typical PUREX solvent, tributyl phosphate (TBP) dissolved in n-dodecane or similar hydrocarbon diluents (the “solvent”). First, the plutonium is reduced by nitrite anion to the +4 valence state (Pu⁺⁴) by the following reaction:

PuO₂(NO₃)₂+NaNO₂+2HNO₃→Pu(NO₃)₄+NaNO₃+H₂O

### See RHO-MA-116, p. 6-9, 1982, PUREX Technical Manual, Rockwell Hanford Operations, Richland, Wash.

Plutonium and uranium are then co-extracted into the solvent phase per the following reactions, leaving the minor actinides and almost all of the fission products in the aqueous phase.

Pu⁺⁴+4NO₃⁻+2TBP(org)→Pu(NO₃)₄.2TBP(org)

UO₂⁺²+2NO₃⁻+2TBP(org)→UO₂(NO₃)₂.2TBP(org)

### RHO-MA-116, p. 6-4.

Technetium is known to co-extract into the solvent. Technetium is removed (i.e. back-extracted) from the solvent in the PUREX-NPC™ process using concentrated nitric acid. Technetium back-extracted from the solvent is a well understood process. Researchers at the Japan Atomic Energy Research Institute and Savannah River National Laboratory in South Carolina have demonstrated technetium back-extraction using variants of the PUREX process, see Technetium Separations for Future Reprocessing, 2005, T. Asakura et al, Journal of Nuclear and Radiochemical Sciences, Vol. 61, No. 3, p 271-274; and WSRC-TR-2002-00444, 2002, Demonstration of the UREX Solvent Extraction Process with Dresden Reactor Fuel Solution, M. C. Thompson et al, Westinghouse Savannah River Company, Aiken S.C.

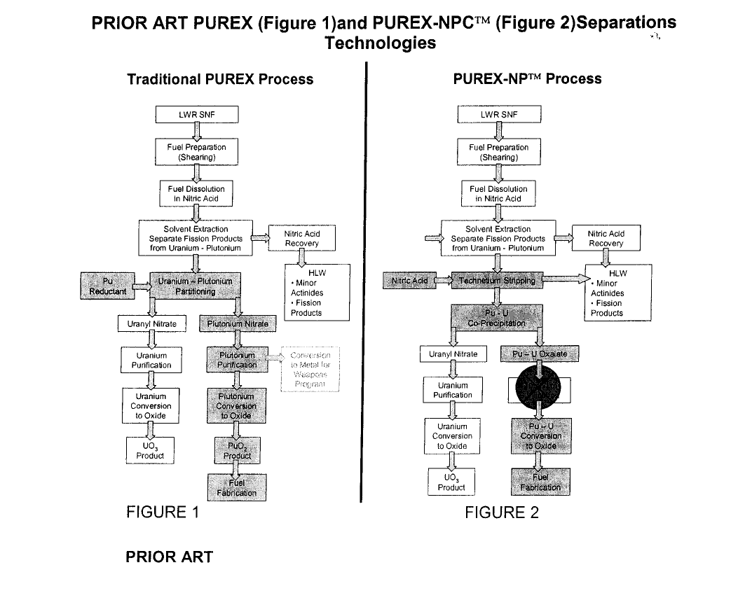

The traditional PUREX process reduces plutonium to the +3 valence (Pu⁺³) stage using a reductant such as ferrous sulfamate, as shown in the following reactions. The sulfamic acid prevents nitrite from oxidizing Pu⁺³ to Pu⁺⁴, thereby allowing plutonium to be separated from uranium. See FIG. 1.

Pu(NO₃)₄.2TBP_{(org)}+Fe⁺²→2TBP_{(org)}+Pu(NO₃)₃+Fe⁺³

HNO₂+NH₂SO₃⁻→N₂+H⁺+SO₄⁻²+H₂O

The PUREX-NPC™ process does not separate plutonium from uranium. Instead, plutonium and uranium are stripped together from the solvent using dilute (approximately 0.1M) nitric acid. In the PUREX-NPC™ process, plutonium is co-precipitated with a small amount of uranium by addition of oxalic acid as indicated by the following reactions:

Pu(NO₃)₄+2H₂C₂O₄+6H₂O→Pu(C₂O₄)₂+4HNO₃

UO₂(NO₃)₂+H₂C₂O₄+3H₂O→UO₂(C₂O₄).3H₂O+2HNO₃

The majority of the uranium remains in solution and is separated from the oxalate precipitate. Complete separation of the uranium solution from the oxalate precipitate is not necessary, since any remaining solution will not interfere with the subsequent calcination of the oxalate precipitate to from plutonium oxide and uranium oxide.

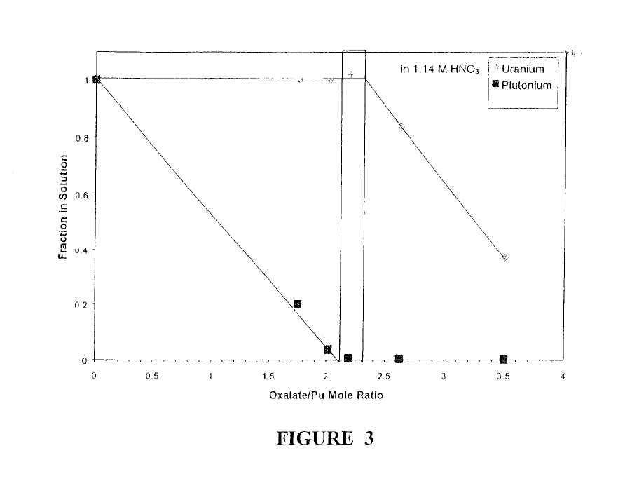

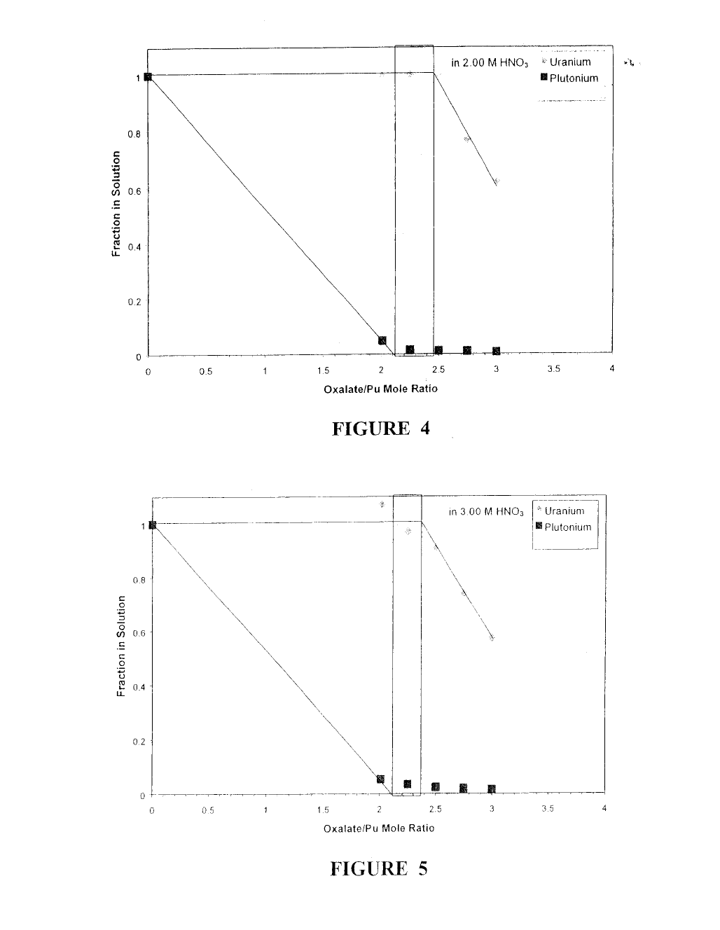

FIGS. 3-5 show the extent of uranium and plutonium precipitation at 90 minutes as a function of the ratio of oxalate to plutonium under various conditions. As can be seen under the conditions employed, most of the plutonium precipitates as an oxalate when the mole ratio of oxalic acid to plutonium approaches 2.1. The bulk of the uranium remains in solution at this ratio. The uranium begins precipitating when the oxalate to plutonium mole ratio is greater than 2.3. An increase in the oxalate to plutonium mole ratio above 2.3 results in additional precipitation of uranium oxalate with the already precipitated plutonium oxalate. The ratio of uranium to plutonium oxalate can be readily adjusted by increasing or decreasing the oxalate to plutonium mole ratio.

In a preferred embodiment, the plutonium content of the final mixed oxide is 10-20 wt %, although the amount of plutonium can be as high as 90%.

The oxalate co-precipitation and subsequent calcination of plutonium with varying amounts of uranium was recently demonstrated at the Hanford site in Richland Wash., see PNNL-13934, 2002, Critical Mass Laboratory Solutions Precipitation, Calcination, and Moisture Uptake Investigations, C. H. Delegard et al, Pacific Northwest National Laboratory, Richland Wash. The mixed plutonium and uranium oxalate precipitate is calcined and converted to a mixed oxide powder. Any residual uranyl nitrate dissolved in the interstitial liquid of the oxalate precipitate is also converted to uranium oxide. The mixed plutonium and uranium oxide can be fabricated into fuel for use in commercial reactors. The uranyl nitrate solution separated from the oxalate precipitate is calcined separately to convert uranium to an oxide.

What is claimed is:

1. A process for treating spent nuclear fuel comprising the steps of:
(a) dissolving spent nuclear fuel in an acidic solution in the presence of an agent that reduces Pu⁺⁶ to Pu⁺⁴ and an agent that oxidizes Pu⁺³ to Pu⁺⁴;
(b) extracting U⁺⁶ and Pu⁺⁴ from said acidic solution with an organic solvent comprising a ligand that binds U⁺⁶ and Pu⁺⁴ to form U⁺⁶ and Pu⁺⁴ ligand complexes that are soluble in said organic solvent;
(c) jointly back-extracting U⁺⁶ and Pu⁺⁴ from said organic solvent with an acidic aqueous solution; and
(d) precipitating a mixture of U⁺⁶ and Pu⁺⁴ by adding a carboxylic acid to said aqueous solution.

2. The process of claim 1 further comprising calcinating said precipitate to form a mixed metal oxide of PuO₂ and UO₃.

3. The process of claim 2 further comprising fabricating said mixed metal oxide into fuel.

4. The process of claim 1 wherein the supernatant of said precipitating step (d) comprises U⁺⁶ and said process further comprises calcinating said supernatant to form UO₃.

5. The process of claim 1 wherein the remainder acid solution remaining after said back-extracting of step (c) comprises Np⁺⁵.

6. The process of claim 1 wherein said acid solution of step (a) further comprises Tc⁺⁷ and said method further comprises extracting Tc⁺⁷ into said organic solvent and then back-extracting Tc⁺⁷ from said organic solvent with a second acid solution before said back-extraction of said U⁺⁶ and Pu⁺⁴.

7. The process of claim 1 wherein said acid solution of step (a) contains less than 0.01M nitrite and initially comprises Np⁺⁵, wherein said Np⁺⁵ is oxidized to Np⁺⁶ by nitrite and extracted in step (b) into said organic solvent.

8. The process of claim 7 wherein said Np⁺⁶ is reduced to Np⁺⁴ using hydrazine and heat and then co-precipitated with said U⁺⁶ and Pu⁺⁴ during said precipitating step.

9. The process of claim 8 further comprising calcinating the co-precipitates to form a mixed metal oxide of UO₃, PuO₂ and NpO₂.

10. The process of claim 1 wherein said acidic solution comprises 1-4M nitric acid, said organic solvent comprises n-dodecane, said ligand comprises tributyl phosphate, said back-extracting of plutonium and uranium from said organic phase is with 0.1M nitric acid, and said carboxylic acid comprises oxalic acid.

11. The method of claim 6 wherein said organic solvent comprises n-dodecane, said ligand is tributyl phosphate, and said back-extracting of Tc⁺⁷ from said organic solvent is with 6M nitric acid.
